(19) United States
(12) Patent Application Publication
(10) Pub. No.: US 2004/0016352 A1
(43) Pub. Date: Jan. 29, 2004

(54) Continous conditioning method and apparatus

(76) Inventor: William Schottelkotte, Centerville, OH (US)

Correspondence Address: Frost Brown Todd, 2200 PNC Center, 201 East Fifth Street, Cincinnati, OH, 45202, US

(21) Appl. No.: 10/433,247

(22) PCT Filed: Nov. 29, 2001
(86) PCT No.: PCT/US01/44532

(51) Int. Cl. A23L 1/00

(52) U.S. Cl. 99/485

(57) ABSTRACT

The cooked or dried product from a continuous cooker, comprising fat, protein and residual moisture is required by EU regulations to be processed at a minimum temperature of 133° C. and 3 bar (absolute) pressure for at least 20 minutes. The conditioning system of the present invention is designed to assure that cooked/dried product is continuously processed in accordance with EU directives regarding temperature, pressure and retention time for processing animal by-products.

### BACKGROUND OF THE INVENTION

The present invention relates to a device and process for rendering and conditioning animal products. More particularly, it concerns conditioning animal by-products, for example material from slaughter houses, packing houses and the like, under high temperature and pressure to minimize the risk of contamination by pathogens, e.g., transmissible spongiform encephalopathy (TSE).

A. Transmissible Spongiform Encephalopathy (TSE)

Various health agencies worldwide have declared that the feeding to ruminants of protein derived from potentially transmissible spongiform encephalopathy (TSE)-infective tissues may cause TSE in animals. TSE's are progressively degenerative central nervous system (CNS) diseases of man and animal that are fatal. Epidemiologic evidence gathered in the United Kingdom (U.K.) suggests an association between an outbreak of a ruminant TSE, specifically bovine spongiform encephalopathy (BSE) and the feeding to cattle of protein derived from sheep infected with scrapie, another TSE. Also, scientists have postulated that there is an epidemiological association between BSE and a form of human TSE, new variant Creutzfeldt-Jakob disease (nv-CJD) reported recently in England.

BSE is a transmissible, slowly progressive, degenerative disease of the CNS of adult cattle. This disease has a prolonged incubation period in cattle following oral exposure (2 to 8 years) and is always fatal. BSE is characterized by abnormalities of behavior, sensation, posture, and gait. These signs are similar to those seen in sheep that are infected with scrapie. BSE is associated with spongiform lesions in the gray matter neuropil of the brainstem and neuronal vacuolization.

The cause of TSE's is controversial. The TSE agent (1) is presumably smaller than most viral particles and is highly resistant to heat, ultraviolet light, ionizing radiation, and common disinfectants that normally inactivate viruses or bacteria; (2) causes little detectable immune or inflammatory response in the host; and (3) has not been observed microscopically. Resistances of the TSE agent to physical and chemical methods that destroy nucleic acid have essentially ruled out conventional microbiological agents as the cause. Currently, the infectious protein or prion theory is favored. Other proposed causes are an unconventional virus, consisting of virus-coded protein and virus-specific nucleic acid with unconventional properties, and a “virino” consisting of a core of nontranslated nucleic acid associated with host cell proteins.

There have been several studies on the inactivation of TSE agents. The only broad generalization that can be drawn is that agents that denature protein can diminish the infectivity of the TSE agents. TSE infectivity does not appear to be markedly diminished by radiation or UV-light.

B. Processing Animal Tissues for Feed Ingredients

Rendering is the process of cooking raw material to remove the moisture and fat from the solid protein portion of animal tissues. Modern rendering systems are high-technology recycling processes that efficiently convert animal byproducts (shop fat and bone, beef and pork slaughterhouse materials, poultry offal, fish, etc.) to stable protein and fat supplements for feed.

Rendering produces a liquid phase, which consists essentially of fats and oils, and a solid phase, which consists essentially of meat and bone meal. The solid phase is usually high in protein and processed into animal feed. The liquid phase is separated into tallow and waste process water.

Current technology consists of four basic types of rendering systems—batch cooker, continuous cooker, continuous multi-stage evaporator, and continuous preheat/press/evaporator. All systems consist of three basic steps: Grinding the raw material, cooking it to remove moisture, and separating the melted fat from the protein solids.

Batch cookers are multiple units, each consisting of a horizontal, steam-jacketed cylindrical vessel with an agitator. Batch cookers are operated at atmospheric pressure. The cooked material is discharged to the percolator drain pan, which contains a perforated screen that allows the free-run fat to drain and be separated from the protein solids known as “tankage.”

Because “tankage” contains considerable fat, it is processed through a press to complete the separation of fat from solids. The fat discharged from the press usually contains fine solid particles that are removed by eithersettling, centrifuging or filtration. The protein solids discharged from the press are known as “cracklings,” which normally are screened and ground with a hammer mill to produce protein meal.

The continuous cooker rendering system normally consists of a single continuous cooker, operating at atmospheric pressure. The discharge from the continuous cooker usually passes across either a vibrating screen or stationary perforated screen to allow the free-run fat to drain. The subsequent steps in the continuous cooker rendering process are similar to those described before for the batch cooker.

In the continuous multi-stage evaporator rendering system, crushing is used as the first stage of size reduction of the raw material. A fat recycle stream is then used to deliver the material as a pumpable slurry through the secondary grinding step to reduce further the particle size. Particle size and fat ratios are important components of this system. The slurry discharge from the final stage of evaporation is pumped to a centrifuge that removes most of the fat and part of it is recycled back to the second stage of size reduction. The solids discharged from the centrifuge are conveyed to screw presses which complete the separation of fat from the protein solids.

C. European Commission Regulations

In 1988, the role of meat and bone meal (MBM) in the transmission of bovine spongiform encephalopathy (BSE) was shown (Wilesmith J W, Wells G A H, Cranwell M P, Ryan J B M. Bovine spongiform encephalopathy: epidemiological studies. Vet Rec 1988; 123: 638-44). These animal foodstuffs are prepared with animal by-products from the slaughterhouse and rendering plants. It has been postulated that changes to the rendering process (lowering of the temperature and change of the fat extraction process) of MBM led to a failure of an infectious agent inactivation and had been therefore associated with BSE. The European Union (EU) had become aware of the risk that the British epidemic might spread to other European countries as a result of British exports of MBM and heat treatment of MBM, in compliance with recommendations by the European Community became mandatory in February 1998.

The Council of the European Union, Decision of Jul. 19, 1999 on measures applying to the processing of certain animal waste to protect against transmissible spongiform encephalopathies and amending Commission Decision 97/735/EC (1999/534/EC) provides minimum requirements for the processing of mammalian animal waste as:

(a) Maximum particle size 50 mm

(b) Temperature >133° C.

(c) Pressure (absolute) at 3 bar; and

(c) Time of 20 minutes without interruption

Pressure (absolute) is produced by saturated steam at 3 bar. Processing may be carried out in a batch or a continuous system.

In the present invention, the raw material is subjected heat and pressure in a continuous manner to meet minimum requirements for processing the raw material as set by the European Union (EU).

### BRIEF SUMMARY OF THE INVENTION

The present invention provides an apparatus and methods for the continuous conditioning of organic materials. More specifically, the present invention provides for a conditioning system designed to assure that rendered animal byproducts are processed in accordance with European Union directives regarding temperature, pressure, and retention time for processing such animal byproducts.

The present invention relates to an improved process for rendering and conditioning organic raw material comprising oil, water and solids, comprising the steps of:

reducing the organic raw material to a plurality of raw material particles and adding at least enough additional fat to make a pumpable slurry;

cooking the raw material to remove substantially all the water to form a dewatered oil and solids residue; and

continuously conditioning the dewatered oil and solids residue under minimal conditions to form a conditioned product.

The present invention also relates to an apparatus for the continuous conditioning of organic material having:

a. a vessel comprising an internal chamber having an entry end with an inlet opening and an exit end with a discharge opening;

b. an entry pump fluidly connected with the inlet opening for delivering material into the vessel;

c. an exit valve fluidly connected with the discharge opening for discharge of material from the vessel;

d. an elongated conveyor positioned within the vessel and capable of conveying material from proximal to the entry end to proximal to the exit end;

e. wherein the vessel is connectable to a source of pressure and wherein the vessel is connectable to a source of heat;

f. wherein the vessel is adapted to maintain minimal conditions within the vessel; and

g. whereby material to be conditioned enters the vessel from the entry pump, passes substantially through the vessel from the entry end to the discharge end, and exits the vessel through the exit valve.

Preferably, the conveyor, entry pump and exit valve operate such that material is conveyed from the entry pump to the exit valve in a time no less than 20 minutes.

The preferred vessel substantially maintains an internal temperature of not less than 133° C. and substantially maintains an internal pressure of not less than 3 bar absolute.

Finally, the present invention encompasses a method for continuously conditioning organic material. In this method, the material is continuously fed into a conditioner for a time no less than 20 minutes and wherein the material is maintained at a temperature of not less than 133° C. and at a pressure of not less than 3 bar absolute.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a flow chart representing the general process of rendering and conditioning.

FIG. 2 represents a schematic drawing of conditioning vessel integrated into a rendering process plant.

FIG. 3 is a schematic drawing of the conditioning vessel.

FIG. 4 shows a detailed configuration of a conditioning vessel.

FIG. 5 shows a typical piston pump.

FIG. 6 shows a rotary valve that can be used in the present conditioning device.

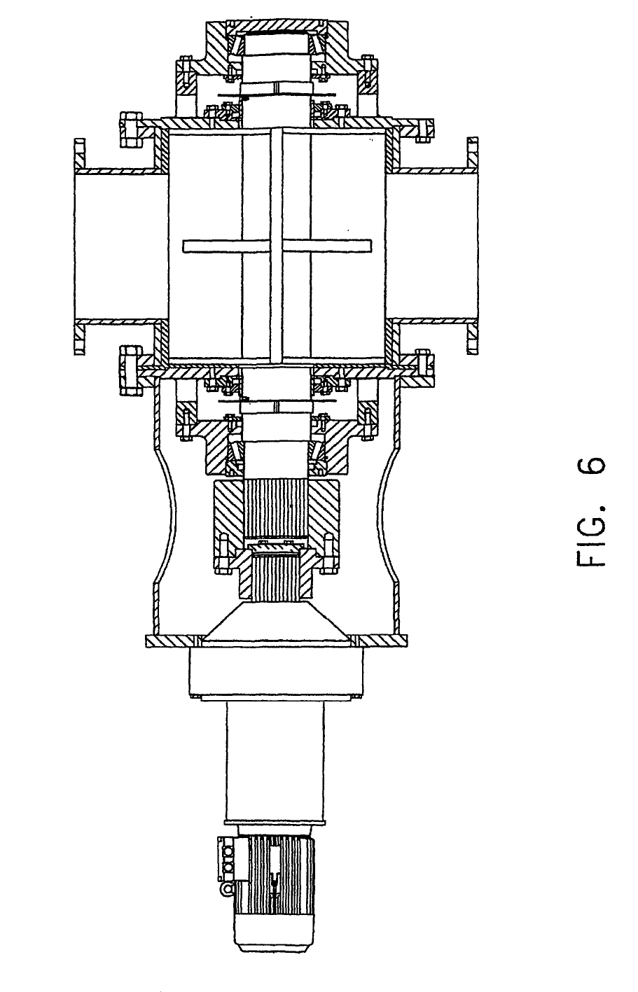

FIG. 7 shows a typical Programmable Logic Control configuration for a conditioning vessel.

### DETAILED DESCRIPTION OF THE INVENTION

Numerous techniques and processes for rendering have been known and utilized. See U.S. Pat. Nos. 5,965,184, 5,725,897, 4,966,733, 4,619,789, 4,289,067, 4,275,036, 4,259,252, 4,168,418, and 4,166,836, incorporated herein by reference in their entirety. In addition, various manufacturers (notably the Dupps Company of Germantown, Ohio and the Stord-Bartz Company of Bergen, Norway) have developed continuous autoclaves or cookers that allow continuous feeding of cooked raw material and discharging of conditioned product.

As used herein, “rendering” or “cooking” refers to the process in which fats and oils are rendered or removed from fat and oil bearing organic raw materials such as animal byproducts. The rendering process comprises reducing the particle size of the raw material, heating the reduced raw material in a rendering vessel to a rendering temperature without the introduction of any processed water while establishing fluidization of the raw material within the oil resident in the rendering vessel to remove substantially all of the water. The rendering process produces a cooked or rendered product. As used herein, “cooked product” or “rendered product” refers to dewatered oil and solids residue obtained from raw material that has been subjected to rendering wherein substantially all of water is removed.

As used herein, “conditioning” refers to the processing of cooked or partially rendered raw materials to provide the minimal conditions for processing the raw materials. As used herein, “conditioned product” refers to the cooked raw material that has been subjected to the minimal conditions for processing raw materials. As used herein, “minimal conditions” refers to the rules as set out by the Council of the European Union (1999/534/EC) on measures applying to the processing of certain animal waste to protect against transmissible spongiform encephalopathies. The minimum conditions are set forth as:

(a) Maximum particle size of 50 mm;

(b) Temperature greater than 133° C.;

(c) Pressure (absolute) at 3 bar; and

(c) Time of 20 minutes without interruption

The pressure (absolute) required is preferably produced by saturated steam at 3 bar. As used herein, “saturated steam” means that substantially all of the air is evacuated and replaced by steam in the conditioning chamber.

The methods described herein are called “dry” methods in the trade because no water is added to the raw material to assist in the extraction of fat. There are also several variations of “wet” rendering methods, which could also be used in the present system. In wet rendering methods hot water is added to the raw material to extract the fat.

The organic raw material is typically of animal origin, such as the tissue, muscle, hide, blood, bone, viscera, flesh, fat, bones, offal (viscera), and blood of fish, pork, poultry, beef, other livestock animals. It includes those portions of the animals obtained as by-products during the preparation of the animals for edible use as well as whole animals when they are not used edibly. The raw material is generally derived from slaughter houses, packing houses and the like.

Although the raw material may contain matter which would not otherwise be classified as solid, fat, or water, it is typical in the art to refer to the raw renderable material as containing only solids, fat, and water, and, for the sake of simplicity of description, that convention is used in this description. As used herein, the words oil, fat, grease, and tallow are generally used interchangeably in this description when referring to matter removed from the rendered material.

It is currently known to condition raw material as set forth in the European Union directives in a batch or continuous process. The present invention now provides a continuous conditioning process in which cooked or partially rendered material is continuously fed into a conditioning vessel under proper conditions of temperature and pressure.

Referring now to the drawings wherein the showings are for purposes of illustrating the preferred embodiment of the invention only and not for purposes of limiting same, the Figures illustrate a rendering process and system (10) for the rendering of organic raw material into its major component elements comprising water, fat and solid proteinaceous meal.

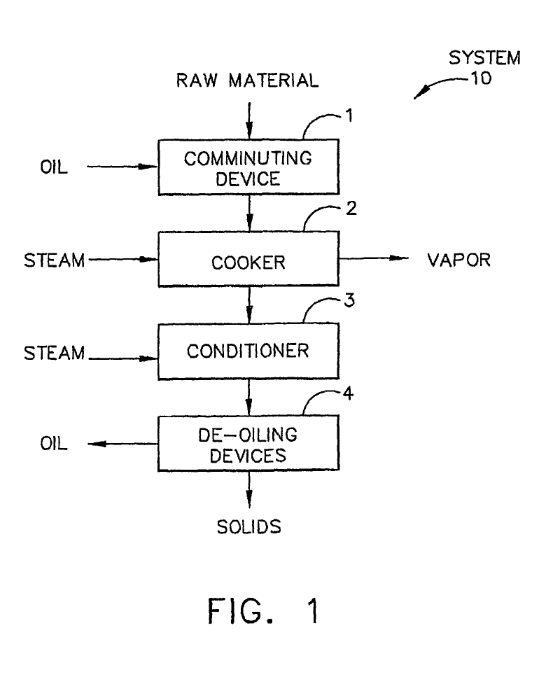

With specific reference to FIG. 1, the general rendering and conditioning system is illustrated by a flow chart. Raw material is fed to a comminuting device (1) to reduce and generally conform the raw material to a plurality of raw material particles having generally preselected particle sizes. The comminuting device (1) typically comprises a grinder to particularly grind up the raw material to a preselected particle size. Hot fat or oil may be added to the raw material during or after the grinding step to facilitate the pumpable transport of the resulting slurry mixture. The added hot fat preferably has a temperature within a temperature range of from about 140° F. to about 270° F. In general, during the entire rendering and conditioning process it is always desirable to keep the temperatures to which the raw material is exposed as low as possible because the lower the temperature in the rendering process, the better the quality of the separated fat and protein solids.

Enough oil is generally added to make the slurry sufficiently fluid to allow it to be pumped, although additional oil may be used, such as to increase the transfer of heat into the raw material. The oil added to the rendering vessel is generally low in water content with the content being less than 10%, preferably less than 3% and under. This ensures that a minimum of water is added back into the cooker. Acids or other additives may be added to the raw material to preserve the material or control odor. The ground material is then transported by a suitable device to a rendering vessel, known in the art as a cooker (2).

The raw material/oil slurry is processed in a conventional continuous cooker (2) operating in a fat bath. Oil is generally added to the cooker and may be recycled oil. The oil added to the cooker is generally low in water content with the content being less than 10%, preferably less than 3% and under. This ensures that a minimum of water is added back into the cooker.

The raw material is cooked and dried in the cooker (2) with both fat and protein temperatures preferably reaching a minimum of about 90° C. to about 135° C. prior to discharge from the cooker. Preferably in the rendering step, substantially all of the moisture is removed so as to obtain a dewatered solids residue with a moisture content in the range of from about 2% to about 6% as measured on a fat free basis, that is the ratio of water to solids is about 2 to about 6%.

In the preferred form, the residence time of the oil/raw material mixture in the cooker is in the range of from about 40 minutes to about 75 minutes. The temperature in the cooker is controlled in the preferred range of about 127° C. to about 143° C.

The rendering vessel of the cooker (2) is generally a horizontal cylindrical vessel containing an internal conveyor and is connectable with a heating source. Generally, the rendering vessels are heated with high-pressure steam. The cooker may be a series of batch cookers or a stack of continuous cookers. There could even be a single large batch cooker from which materials are fed continuously to the conditioner. With continuous cookers, the flows of solids residue and water vapor from the cookers will already be continuous. More preferably, the cookers are continuous vessels that accept moist renderable material at one end and have sufficient residence time so that the material is dried as it is transported through the vessel and discharges continuously at the opposite end.

A heating apparatus such as a heat exchanger or heating jacket generally heats the cooker with the heat derived from indirect steam or other suitable heating mechanism. The cooking process removes substantially all of the water from the raw materials to form a dewatered oil and solids residue. The water is removed in the form of water vapor. The vapors from the cooked material are, according to the invention, collected and directed to a condenser where the vapors are condensed and eventually discharged, usually as waste water.

A control wheel or other suitable controlled discharge device discharges the dewatered oil and solids residue (or cooker product) flow from the cooker at a controlled rate. From the control wheel, a conveyor, e.g., a screw conveyor, transfers cooked product to the conditioner (3).

The cooked product is then pumped into a pressurized vessel referred to as a conditioner (3). An entry pump transfers the material on a continuous basis into the pressurized conditioning vessel, generally. Preferably the rendered material is pumped by a piston pump but may be transported by any means in which the material is moved in a generally continuous manner into the conditioner without blockages or substantial loss of pressure from within the conditioner.

Various pumps for conveying material under pressure are well-known in the art. For example, rotary pumps, centrifugal pumps, reciprocating piston-type pumps, diaphragm pumps, and bellows-type pumps may be used in connection with the present invention. Such pumps are generally configured having inlet and outlet ports that are fitted with seals such as one-way check valves.

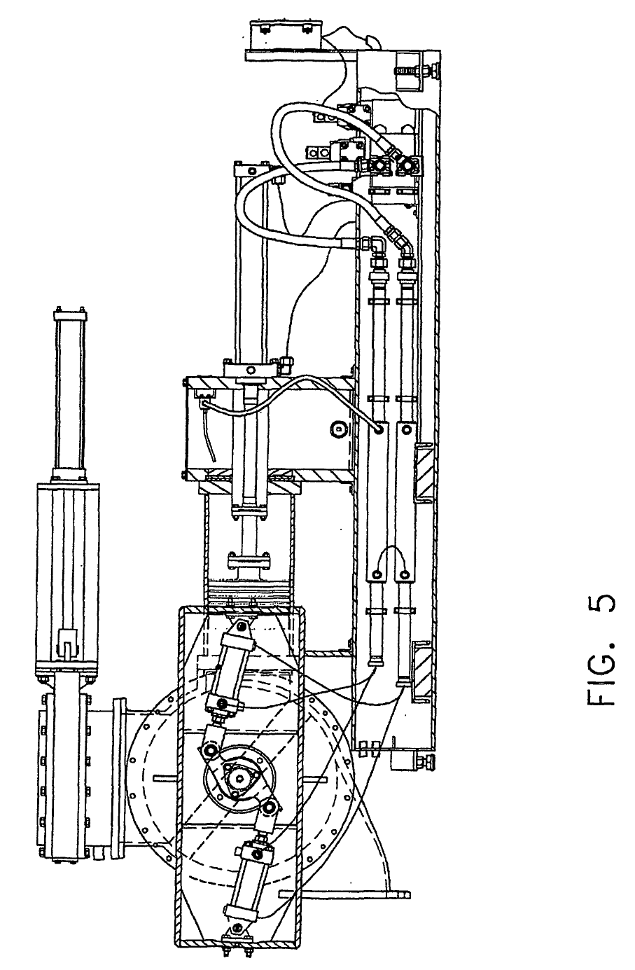

Preferably, the entry pump is a piston pump configured with heavy-duty inlet/outlet slide valves capable of pumping the cooked product into the conditioning vessel operating under a minimum pressure of 3 bar (absolute). Examples of such pumps are Dupps piston pump No. 137660 (Dupps Company, Germantown, Ohio) as illustrated in FIG. 5.

The conditioner (3) is designed to maintain the cooked/dried product at or above 133° C. and 3 bar (absolute) pressure for the 20 minutes required by EU directives. Since the cooked/dried product is usually discharged from the cooker at about 135° C., the product temperature only needs to be maintained in the conditioning vessel with very little additional heat input. If the cooked product is at a lower temperature, it is preferably heated to 133° C. or greater prior to entry into the conditioning vessel. Otherwise, additional heat input into the conditioning vessel is required as well as a longer retention time. Preferably, the pressure in the conditioning vessel is maintained by means of direct boiler saturated steam injection. The injected steam purges air from the conditioner at start up so that the product is maintained in a saturated steam environment while in the conditioning vessel.

The cooked/dried product is transported through the conditioner (3) by a slow speed conveyor, preferably a helical conveyor shaft. The slow rotational speed of the conveyor creates minimal agitation of the product and thus ensures a plug flow of the product through the conditioning vessel. Maintaining a constant level of product in the conditioning vessel controls the cooked product retention time in the conditioning vessel. The combination of plug flow and constant level control ensure that the product is retained in the conditioner for the required 20 minutes (or more) with no short circuiting of product.

The product level, temperature and pressure conditions in the conditioning vessel are continuously monitored. The temperature and pressure conditions are preferably maintained by means of a steam jacket on the conditioning vessel and direct steam injection as mentioned above. The product level is preferably maintained by a combination of variable conveyor shaft speed and a controlled discharge rate.

The product is discharged from the conditioner (3) on a continuous basis, generally by means of an exit valve. Preferably, such valve is a heavy-duty rotary valve. The rotary valve is preferably equipped with a variable speed drive to control the conditioning vessel discharge rate as mentioned above. The product discharged from the rotary valve is conditioned product as defined by EU directives.

From the exit valve a conveyor may then transfer the conditioned product (dewatered oil and solids residue) to one or more de-oiling devices (4) (e.g. existing draining, settling and pressing devices as known in the art) for primary separation of fat from solids. The drained solids and fat from the de-oiling device (4) are further processed in a conventional manner by the de-fatting and clarification sections of the rendering process.

Some of the oil may be recycled to the cooker feed. The remaining oil is cleaned and dried by conventional methods to produce the final oil product. The final solids product consists of the dewatered, deoiled solids residue resulting from the final deoiling in device (4). Preferably, substantially all the remaining oil is removed by device (4); however, there remains some residual oil in the resulting dewatered, deoiled solids residue. The amount of this residual oil varies, and it depends principally on the nature of the raw material and the efficiency of device (4). With a fairly efficient device, the final solids product comprises about 7% to about 13% by weight of fat. The final fat product consists of the dewatered fat with minimal solids and water content. With a fairly efficient clarification device, the final solids content of the fat comprises from about 0.5% to about 1% by weight of the solids, and from about 0.5% to about 1% by weight of water.

A programmable logic controller (PLC) with appropriate instrumentation and control devices is used for process control. All process controls and critical control parameters for the conditioning vessel module are monitored by the PLC and controlled from the plant operating control panel. Critical control parameters are data logged by computer for official review and use by local authorities.

In the unlikely event that one of the required retention time, temperature or pressure parameters goes out of tolerance during conditioning vessel operation, the product discharged from the conditioning vessel rotary valve is immediately and automatically returned to the cooker to be conditioned again. This recycling of material continues until all parameters are once again in the acceptable range.

One reason that the continuous conditioning process is an improvement over the batch process is that it provides a continuous discharge of conditioned material from the conditioning vessel. This discharge may be sampled in order to monitor the temperature, consistency, and other characteristics of the material. The information can then be used to adjust the material input, temperature, retention time and other variables of the conditioner.

Conveying of material to and from the individual processing equipment can be by means of either pump, screw conveyors, belt conveyors or pneumatic conveyors or chutes.

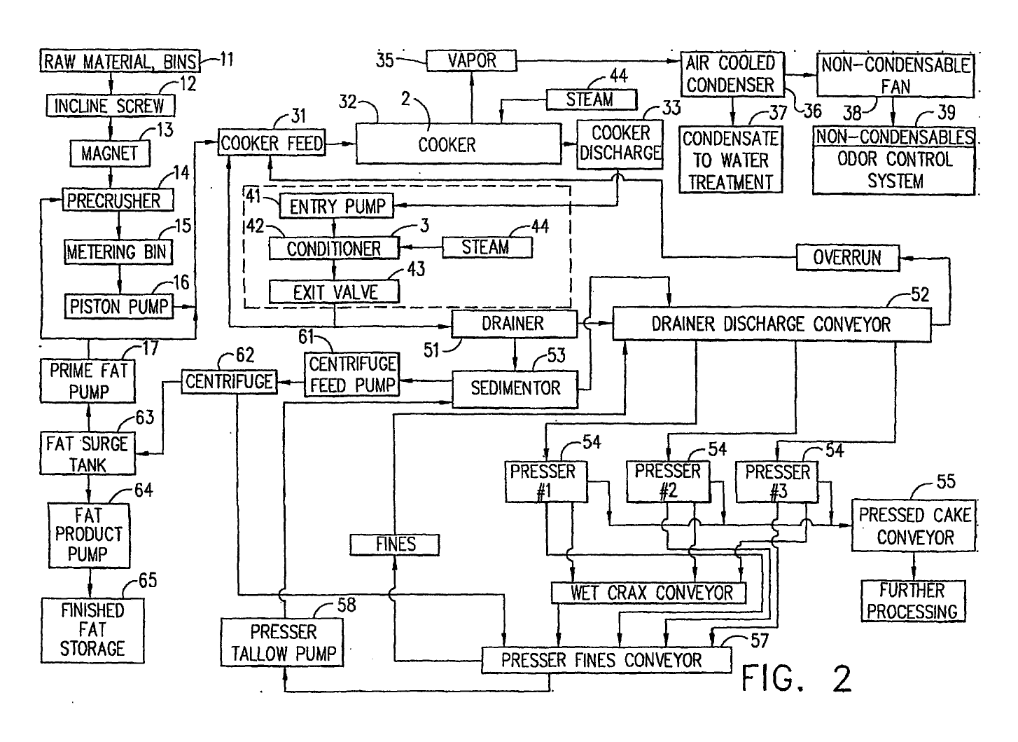

With particular reference to FIG. 2, the conditioning method of the present invention is shown in a schematic drawing of the rendering and conditioning system integrated into a general rendering process plant. The raw material to be rendered is initially stored and provided to the system from a raw material bin (11). The raw material is first conveyed to a raw material grinder or a precrusher (14) by use of an inclined screw conveyor or other conveyor (12). In the grinder, the raw material is ground up to a pre-selected particle size. The raw material will often be passed over a magnet (13) before or during grinding to remove ferrous metal objects. From the grinder, the sized raw material is transported to the metering bin (15) for temporary storage prior to being metered into the cooker by a piston pump (16).

A flow rater and prime fat supply pump (17) operate to provide an additional mixture of hot fat to the piston pump as needed to facilitate the pumping of the ground raw material to the cooker (2) [not shown in figures]. The mixture of fat lubricates the pumping operation. The ground raw material particles received in the metering bin (15) are mixed with a controlled amount of fat at a particular temperature to provide transport convenience of the resulting slurry.

The sized raw material is then pumped by a feed pump or piston pump (16) to a cooker feed or feed screw (31) to provide the sized raw material to the cooker (2). The cooker feed (31) provides a measured rate of supply of the sized raw material to the cooker module (2) so that the raw material can be exposed for a preselected time at a preselected temperature in the cooker. Such control is effective in solublizing the proteins in the raw material and breaking the water and fat emulsions contained therein so that the raw material will ultimately include a generally continuous phase of fat and a generally continuous phase of water. The cooker (2) also includes an input source of hot vapor or steam (44) from a source of heated vapor to heat the raw material pumped into the cooker. Preferably the raw material is retained within the cooker (2) for a period within a range of from about 40 to about 75 minutes at a temperature within a range of from about 87° C. to about 138° C. Preferably the raw material is cooked and dried in the cooker (2) with both fat and protein temperatures preferably reaching a minimum of from about 130° C. to about 135° C. prior to discharge from the cooker (2).

Water vapor (35) from the water evaporated from the raw material is removed from the cooker to an air cooled condenser (36), which then provides a condensate. The condensate may then be transferred to a water treatment facility. Non-condensable gases are removed from the condenser by a non-condensable fan (38) and transported to the odor control system (39). Preferably in the rendering step, substantially all of the moisture in the raw material is removed so as to obtain a cooked product (dewatered solids residue) with a moisture content in the range of from about 2% to about 6% as measured on a fat free basis, that is the ratio of water to solids is about 2 to about 6%.

The cooker (2) generally comprises a horizontal cylindrical vessel (32) containing an internal agitator or conveyor is preferably steam heated and usually, but not necessarily, also has an external steam jacket. The continuous cooker thereby operates to insolubalize the proteins and de-emulsify the slurry to form a continuous phase of fat and a protein solids. The partially dried slurry then is communicated to the conditioning vessel (3). A cooker discharge (33), such as a control wheel or other suitable control discharge device, discharges the fat and protein product flow from the cooker (2) at a controlled rate.

From the cooker discharge (33) the rendered product is communicated to the conditioning vessel (3) by means of a conveyor such as a screw conveyor. The rendered material then enters the conditioning vessel (3) by means of an entry pump (41). Preferably the entry pump (41) is a piston pump configured with heavy duty inlet and outlet slide valves capable of pumping the cooked material into the conditioning vessel while operating under a minimum pressure of 3 bar absolute. The conditioner (3) is comprised of a conditioning vessel (42) designed to maintain the cooked product at or about 133° C. and 3 bar absolute pressure for the 20 minutes residence time required by the EU directives. The product temperature within the conditioning vessel (42) is maintained by an input of heat (44) to the jacket of the conditioning vessel. Preferably, steam also provides the pressure in the conditioning vessel (42) by means of direct boiler steam injection. The injected steam purges substantially all of the air from the conditioning vessel at start-up so that the product is maintained in a steam environment. The conditioning vessel (42) may be, but not necessarily, outfitted with an external heating jacket. The conditioning vessel (42) has preferably an internal helical conveyor with a variable speed drive to provide for the controlled movement of solid particles through the conditioner (3).

The conditioned product is discharged from the conditioning vessel (42) by means of an exit valve (43). Preferably such exit valve (43) is a heavy duty rotary valve capable of cutting or crushing any bits of bone that may reach the valve in order to prevent the valve from jamming. The rotary valve is preferably equipped with a variable speed drive to control the conditioning vessel discharge rate. The product as discharged from the rotary valve is conditioned product as defined by the EU directives.

From the exit valve (43), the product is transferred to a deoiling/defatting device such as a drainer (51) that drains oil from the solids. Generally the product is conveyed by means of a screw conveyor. From the drainer (51), drained liquid is moved to a sedimenter (53) that will separate liquids such as fats and from solids such as the proteinacious material. The solid material will move to a drainer discharge conveyor (52) and onto a pressing device (54) for further pressing the drained solids to remove the majority of the remaining fat. Solids from the sedimenter (53) are conveyed to the drainer discharge conveyor (52). Fat from the sedimenter is moved by a centrifuge feed pump (61) to a centrifuge (62). The centrifuge (62) acts to segregate the fat from the solids. The centrifuge (62) operates to split the slurry into two product streams comprising a first stream of fat-wet solids, which are communicated to the presser fines conveyer (57) and thence to the drainer discharge conveyor, and a second stream of polished fat or oil, which is communicated to a fat surge tank or a fat storage tank (63). From the fat surge tank, one portion of the fat is communicated to a finished fat storage tank (65), and a second portion may be communicated to a prime fat pump (17). The fat emanating from the centrifuge (62) generally contains less than about 0.5% by weight of insoluble solids and less than about 0.5% by weight of water. The fat communicated to a prime fat pump (17) may either be communicated into the raw material before during or after grinding.

Fat removed from the solids in the presser (54) contains some residual solids and is communicated to the presser fines conveyor (57) wherein the fat is drained from the solids by means of a screened section in the conveyor. The drained fat from the presser fines conveyor is transported to the sedimenter by the presser tallow pump (58). The solids from the presser fines conveyor are conveyed back to the drainer discharge conveyor (52) to be recycled through the pressers (54). Solids may be redirected through the pressers (54) one or more times, eventually resulting in a pressed cake removed by a pressed cake conveyor (55) and on for further processing. The solids emanating from the presser (54) generally contains less than about 11% by weight of fat and 3% by weight water. The solids thus produced comprise a finished solids product and may be sized and bagged or shipped in bulk.

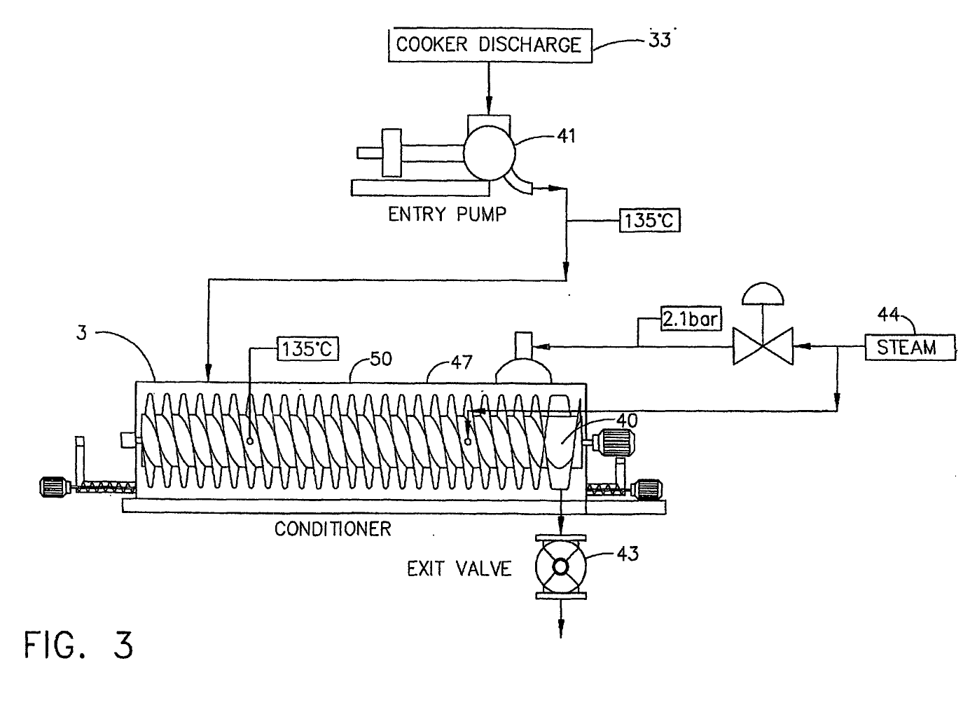

With particular reference now to FIG. 3, a conditioner device formed in accordance with the present invention is illustrated. The cooked product conveyed from the cooker discharge (33) is conveyed to the entry pump (41). The entry pump (41) is preferably a piston pump for use in conveying materials into a vessel under pressure. The entry pump (41) delivers the rendered material into the conditioner (3) under constant pressure. The conditioner (3) comprises a cylinder (47) having and entry end and an exit end with an inlet opening proximal to the entry end and a discharge opening proximal to the exit end. A connector fluidly connects the inlet opening of the cylinder to the entry pump (41) and a connector fluidly connects the discharge opening of the cylinder to the exit valve (43). The exit valve is preferably a rotary valve.

The conditioning vessel cylinder (47) contains an conveyor (40) positioned in the cylinder adapted for moving the material within the cylinder from proximal the entry end to proximal the discharge end with the material passing through the length of the cylinder. The conveyer (40) is generally a helical conveyor shaft located within the cylinder and rotatably mounted on the cylinder and extending substantially the fall length of the cylinder although any suitable conveyor configuration for advancing the material within the conditioning vessel may be used. Preferably the helical conveyor shaft has a diameter such that the flighting extends substantially the full diameter of the cylinder (47).

The interior of conditioning vessel cylinder (47) adaptedly connected to a source of pressure such as steam, air, carbon dioxide or nitrogen for creating pressure within the cylinder. The conditioning vessel (42) usually, but not necessarily, also is outfitted with an external heating jacket (50), which has a source of heat such as electric heating coils or oil or gas fired burners or is connected to a source of heat such as steam, or hot air or fluid. The entry pump (41) and exit valve (43) will generally also contain seals for substantially preserving the pressure within the cylinder (47).

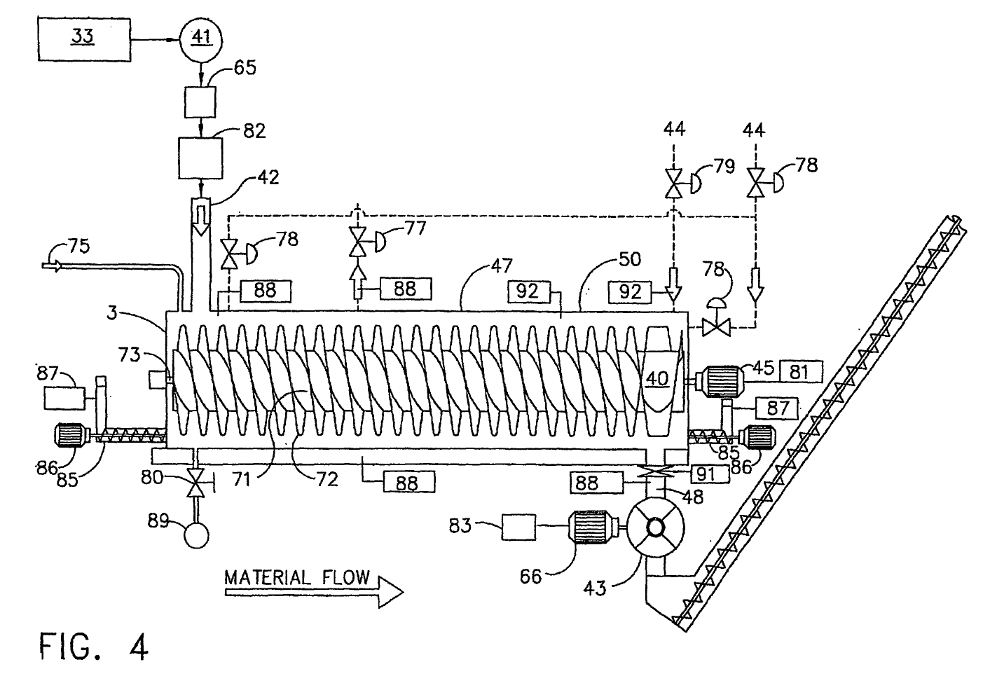

With particular reference to FIG. 4, an example of a conditioning system formed in accordance with the present invention is more particularly illustrated. The cooked product conveyed from the cooker discharge (33) is conveyed to the entry pump (41). The entry pump (41) is preferably a piston pump for use in conveying materials into a vessel under pressure. The entry pump (41) delivers the rendered material to the conditioner (3) under constant pressure. The conditioner (3) comprises a cylinder (47) having and entry end and an exit end with an inlet opening in the entry end and a discharge opening in the exit end. A connector (42) fluidly connects proximal the entry end of the cylinder to the entry pump (41) and a connector (48) fluidly connects proximal the exit end of the cylinder to the exit valve (43). The exit valve is preferably a rotary valve. The interior of conditioning vessel cylinder (47) is adaptedly connected to a source of pressure such as steam, air, carbon dioxide or nitrogen for creating pressure within the cylinder. Preferably, the pressure means is by steam injection at a temperature of at least about 135° C. The conditioning vessel (47) usually, but not necessarily, also is outfitted with an external heating jacket (50), which has a source of heat such as electric heating coils or oil or gas fired burners or is connected to a source of heat such as steam, or hot air or fluid. The entry pump (41) and exit valve (43) will generally also form a seal for substantially preserving the pressure within the cylinder (47).

The conditioning vessel cylinder (47) contains an conveyor (40) positioned in the cylinder adapted for moving the material within the cylinder from proximal the entry end to proximal the discharge end with the material passing through the length of the cylinder. The conveyer (40) is generally a helical conveyor shaft located within the cylinder and rotatably mounted on the cylinder and extending substantially the full length of the cylinder although any suitable conveyor configuration for advancing the material within the conditioning vessel may be used.

Preferably, the helical conveyor shaft has flighting (72) with a diameter such that the shaft extends substantially the full diameter of the cylinder (47). The conveyor shaft (71) has a first and second end. The first end is preferably operatively connected to a first motor (45) capable of rotating the shaft. The second end of the shaft is connected to a support (73) capable of allowing the shaft to rotate. Preferably, the support (73) is a bearing containing an anti-friction substance. The shaft may optionally have a motor operatively connected to both the first and second ends.

In a conditioning vessel as shown in FIG. 4, with a conditioning cylinder diameter of 54 in. and a cylinder length of 26.75 ft. has a screw conveyer with a screw diameter of 53 in., a screw length 26.5 ft., a screw pitch (½ pitch flighting) of 24 in., a cross sectional area of 12.76 ft², a screw conveyer speed of 0.51 RPM, at 60% full, at 135° C. and 3 bar absolute, will condition approximately 25,600 lb/hr of product with a residence time of 20 minutes.

Materials enter the conditioner vessel through the inlet opening proximal to the entry end. The conveyer (40) moves the material from the entry end towards the exit end substantially sequentially through the length of the cylinder (47) by rotational movement of the helical shaft (71). In the preferred mode, materials are substantially prevented from moving forward or reverse within the cylinder nonsequentially by the fighting (72) of the helical shaft (71). As the materials reach the exit end of the cylinder, the materials are removed substantially sequentially from the cylinder through the discharge opening. The rotational movement speed of the helical shaft (71) and the pitch of shaft flighting (72) are such that material is retained within the cylinder (47) for a residence time of no less than 20 minutes.

In one embodiment, the conditioner has a liquid level sensor for sensing the liquid level of material in the conditioning vessel (47). Preferably, such liquid measuring sensor is at each end and the vessel is inclined towards the exit end. The liquid measuring sensor is preferably a small screw conveyor (85) driven by a motor (86) with a diaphragm level transmitter (87) installed on it as well know in the art. The screw conveyor conveys solids towards the conditioner to maintain the level transmitter from becoming plugged up with solids. Preferably the liquid measuring sensor is operatively linked with a controller.

In a further embodiment, the conditioner is outfitted with temperature measuring sensor (88). This is preferably one or more thermocouples that measure the temperature of the material in the conditioner at various points as well as the temperature of the vapor in the conditioner. Preferably the temperature measuring sensor is operatively linked with a controller.

In a further embodiment, the conditioner is outfitted with a conduit and inlet (75) for fat or oil to be added to the interior of the conditioning vessel as needed, preferably by a variable speed pump, in order to maintain the proper liquid level within the vessel. In a yet a further embodiment, the conditioner is outfitted with a shut off valve (80) and a pump (89) for draining residual liquid from the conditioner at shut down.

In a further embodiment, the conditioner is outfitted with a control (91) for regulating the flow from the conditioner to the exit valve (43). The control (91) is preferably a solenoid used to operate a valve, such as a knife gate valve, that controls flow from the conditioner to a rotary valve (49). The knife gate valve is hydraulically actuated and has proximity switches to verify valve position. The knife gate valve is ordinarily in the full open position during operation.

In a further embodiment, the conditioner is outfitted with one or more pressure measuring sensor (92). The sensor is preferably one or more diaphragm type pressure transmitters that measure the respective pressures in the conditioner (47) and in the conditioner pressure jacket (50).

In a further embodiment, the conditioner is outfitted with flow control for regulating the rate of flow of vapor out of the conditioner (77), the rate of flow of steam into the conditioner (78), the rate of flow of steam into the conditioner jacket (79). Preferably, such flow control is operatively coupled with a controller for controlling the rate of flow. Generally, the flow control is electrically or pneumatically operated control valves operated under control of the controller.

In a preferred embodiment, the conveyor (40) is operatively coupled to a first motor (45), preferably a variable speed drive, having a feedback control device (81). A second motor (65) having a feedback control device (82) is operatively coupled to the entry pump (41), and a third motor (66) having a feedback controlled device (83) is operatively coupled to the exit valve (43). A hydraulic control console that allows the pumping rate to be varied preferably powers the entry pump. The first, second and third motors are all operatively coupled to a controller for controlling and synchronizing the conveyor (40) and the entry pump (41) and the exit valve (43).

In the event that one of the required parameters such as retention time, temperature or pressure goes out of tolerance during conditioning operation, the product discharged from the conditioning vessel exit valve (43) is automatically returned to the cooker (2) to be conditioned again. This recycling of material continues until all parameters of the controller are within acceptable range.

Preferably the controller is a programmable logic controller, or PLC, with appropriate instrumentation and is used for process control. More preferably, all process controls and critical control parameters for the conditioning vessel (3) are monitored by the PLC and controlled from the plant operating control panel. Critical control parameters are preferably data-logged by computer for review and use by local authorities. The programmable logic controller may be variably configured and programmed to fit the needs of the particular facility. It controllably produces command signals in response to various input conditions including those controlling motors, controls, sensors, valves, timers, warning alarms, the automatic shutdown of sensitive equipment and processes, and the activation and testing of the secondary power source.

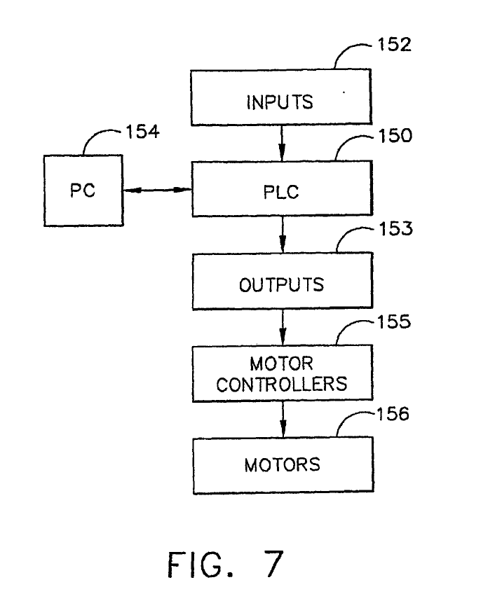

The control system and flow of data for the conditioning system are shown generally in the block diagram of FIG. 7. A programmable logic controller PLC (150) receives data inputs (152) from all of the system parameter sensors. The data inputs (152) to PLC (150) include temperature (e.g., temperature in the conditioning vessel, temperature in the heating jacket, temperature of incoming material, temperature of incoming steam, temperature of exiting material, etc.), pressure (e.g., pressure in the conditioning vessel and pressure in the heating jacket, etc.), flow rates, motor speeds, valve positions, liquid levels and other sensor inputs.

The data outputs (153) from PLC (150) are used to control normal system operation of the conditioning system and for directing condition responses. The data outputs (153) for controlling system operation steps and alarm condition responses include, for example, the data outputs for controlling the opened and closed position of flow control valves (43), (77), (78), (79), (80). Additional data outputs provide control signals for pumps (16), (17), (41), (59), (61), (64), (89), and motors (45), (65), (66), (86).

The programmable logic controller is programmed to recognize threshold values for data inputs (152) for initiating appropriate data outputs (153) for control of system operation steps and condition responses. Thus PLC (150) initiates data output control signals in response to system parameter values monitored by the system parameter sensors reaching or exceeding system parameter threshold values. The PLC (150) is generally coupled to a local computer (154) capable of monitoring system operation from the data inputs (152) and data outputs (153). From the local PC (154) an operator can override system parameter settings or reprogram the PLC (150) for new applications. The automated control system therefore provides flexibility for reprogramming and adapting the automated conditioning system for different materials and applications.

The invention has been described with reference to the preferred embodiment. Obviously, modifications and alterations will occur to others upon the reading and understanding of the specification. It is our intention to include all such modifications and alterations insofar as they come within the scope of the appended claims or the equivalents thereof.

What is claimed is:

1. An improved process for rendering and conditioning organic raw material comprising oil, water and solids, comprising the steps of:
reducing the organic raw material to a plurality of raw material particles and adding at least enough additional fat to make a pumpable slurry;
cooking the raw material to remove substantially all the water to form a dewatered oil and solids residue; and
continuously conditioning the dewatered oil and solids residue under minimal conditions to form a conditioned product.

2. The process according to claim 1, wherein during the cooking step, the raw materials reach a minimum temperature of about 90° C. to about 135° C. for a time from about 30 minutes to about 75 minutes.

3. The process according to claim 2, wherein the substantially all of the moisture is removed during the cooking step so as to obtain a dewatered solids residue wherein the ratio of water to solids is about 2% to about 6%.

4. The process according to claim 3, wherein the continuous conditioning takes place within a conditioner at minimal conditions of least about 133° C. and at least about 3 bar absolute pressure for at least about 20 minutes.

5. The process of claim 4, further comprising the step of removing substantially all the remaining oil from said dewatered solids to form a dewatered, deoiled solids product.

6. The process according to claim 4, wherein the cooking step includes cooking said raw material in a steam jacketed vessel.

7. The process according to claim 4, wherein direct boiler saturated steam injection maintains the pressure in the conditioner.

8. The process according to claim 4, wherein the cooked product is pumped substantially on a continuous basis into the conditioner by an entry pump.

9. The process according to claim 8, wherein the conditioned product is discharged from the conditioner on substantially a continuous basis by an exit valve.

10. The process according to claim 9, wherein the exit valve is a heavy-duty rotary valve equipped with a variable speed drive to control the conditioner discharge rate.

11. The process according to claim 9, wherein the product level, temperature and pressure conditions in the conditioner are continuously monitored by a programmable logic controller.

12. The process according to claim 11, wherein the product level, temperature and pressure parameters in the conditioner are continuously monitored to determine if they are in a pre-determined acceptable range.

13. The process according to claim 12, wherein in the event that one or more of the retention time, temperature or pressure parameters goes out of the pre-determined acceptable range during conditioning, the product discharged from the conditioning vessel rotary valve is re-conditioned until such parameters are within the acceptable range.

14. An apparatus for the continuous conditioning of organic material comprising:
a. a vessel comprising an internal chamber having an entry end with an inlet opening and a exit end with a discharge opening;
b. an entry pump fluidly connected with the inlet opening for delivering material into the vessel;
c. an exit valve fluidly connected with the discharge opening for discharge of material from the vessel;
d. an elongated conveyor positioned within the vessel and capable of conveying material from proximal to the entry end to proximal to the exit end;
e. wherein the vessel is connectable to a source of pressure and wherein the vessel is connectable to a source of heat;
f. wherein the vessel is adapted to maintain minimal conditions within the vessel; and
g. whereby material to be conditioned enters the vessel from the entry pump, passes substantially through the cylinder from the entry end to the discharge end, and exits the cylinder through the exit valve.

15. The apparatus of claim 14, wherein the entry pump is a piston pump.

16. The apparatus of claim 15 wherein the piston pump is capable of pumping material into the vessel while operating under a minimum pressure of 3 bar absolute.

17. The apparatus of claim 14, wherein the exit valve is a rotary valve.

18. The apparatus of claim 17, wherein the entry pump and exit valve provide seal means to substantially maintain the pressure within the vessel.

19. The apparatus of claim 14, wherein the conveyor, entry pump and exit valve operates such that material is conveyed from the entry pump to the exit valve in a time no less than 20 minutes.

20. The apparatus of claim 19, wherein the vessel substantially maintains an internal temperature of not less than 133° C. and substantially maintains an internal pressure of not less than 3 bar absolute

21. The apparatus of claim 20, wherein the conveyor is a helical conveyor shaft located within the cylinder and rotatably mounted within the vessel and extending substantially the full length of the vessel and wherein the helical conveyor shaft has a diameter such that the shaft extends substantially the full diameter of the vessel.

22. The apparatus of claim 21, wherein the vessel is fluidly connected with a source of fat.

23. The apparatus of claim 20, wherein the vessel is fluidly connected to a source of saturated steam injection as a source of heat.

24. The apparatus of claim 23, wherein the source of heat is further provided by a heating jacket that surrounds and extends over a substantial portion of the vessel.

25. The apparatus of claim 24, wherein the heating jacket is fluidly connected to a source of steam.

26. The apparatus of claim 20, wherein the vessel is fluidly connected to a source of saturated steam injection as a source of pressure.

27. The apparatus of claim 26, wherein the apparatus further comprises one or more measuring devices selected from the group consisting of a pressure measuring sensor, a temperature measuring sensor, and a liquid level measuring sensor.

28. The apparatus of claim 27, wherein the apparatus further comprises one or more pressure relief valves.

29. The apparatus of claim 27, wherein the apparatus further comprises one or more inlets for oil to be conducted into to the vessel.

30. The apparatus of claim 27, wherein the apparatus further comprises control means for regulating the flow of material from the vessel to the exit valve.

31. The apparatus of claim 30, wherein the control is a gate valve that controls flow from the vessel to a rotary valve.

32. The apparatus of claim 20, wherein the apparatus further comprises one or more flow control selected from the group consisting of a flow regulator of vapor out of the vessel, a flow regulator of flow of steam into the vessel, and a flow regulator of flow of steam into the steam jacket.

33. The apparatus of claim 32, wherein the flow control is operatively coupled with a controller for controlling the rate of flow.

34. The apparatus of claim 33, wherein the apparatus further comprises:
a first motor having a feedback control device operatively coupled to the conveyor to control the conveyor.
a second motor having a feedback control device operatively coupled to the entry pump;
a third motor having a feedback control device operatively coupled to the exit valve and
a controller operatively coupled to the first, second, and third motors for controlling and synchronizing the conveyor, the entry pump and the exit valve.

35. The apparatus of claim 34, wherein the controller is a programmable logic controller.

36. The apparatus of claim 35, wherein the programmable logic controller monitors process controls and critical control parameters.

37. The apparatus of claim 36, wherein the programmable logic controller receives one or more data from parameters selected from the group consisting of temperatures, pressures, flow rates, motor speeds, valve positions, and liquid levels.

38. The apparatus of claim 37, wherein the programmable logic controller controllably produces command signals in response to various input conditions controlling one or more devices selected from the group consisting of motors, valves, timers, and warning alarms.

39. The apparatus of claim 38, wherein such command signals maintain minimal conditions within the vessel.
